(19) United States
(12) Patent Application Publication
(10) Pub. No.: US 2019/0309996 A1
(43) Pub. Date: Oct. 10, 2019

(54) Autogenous Cooling Method for In Space Storage and Transfer of Cryogenic Rocket Propellants

(71) Applicants: William Jacob Chancery, Huntsville, AL (US); Clayton M. Isherwood, Huntsville, AL (US)

(72) Inventors: William Jacob Chancery, Huntsville, AL (US); Clayton M. Isherwood, Huntsville, AL (US)

(21) Appl. No.: 15/947,301

(22) Filed: Apr. 6, 2018

(51) Int. Cl. F25B 19/00; B64G 1/40

(52) U.S. Cl. CPC F25B 19/005; F25B 2400/12; B64G 1/401

(57) ABSTRACT

The present invention refers to a cryogenic cooling system utilizing rocket propellant as the working fluid in a phase change closed loop process. The purpose of the system is to enable long term zero boil off storage of cryogenic liquid rocket propellant in space. The system will also enable transfer of cryogenic liquid from one tank volume to another in a propellant depot mode of operation.

### BACKGROUND OF THE INVENTION

### Field of the Invention

This invention relates to the field of cryogenic liquid propellant storage and transfer for space travel and exploration.

### Description of Related Art

There is always some heat load coming into a storage tank, even in the vacuum of space. To minimize inert system mass, bulk storage tanks are not designed to contain propellant pressure at equilibrium temperature. Therefore, storage tanks are equipped with pressure relief valves which allow excess vapor pressure to vent. One part of a strategy to minimize liquid boil off loss is to minimize the heat load into the tank. This passive method is accomplished with radiative shielding to block sunlight and thermal standoffs to minimize heat load from structural elements that must not be at cryogenic liquid temperatures.

The other part of a boil off minimization strategy is active cooling. This is typically done with self-contained cryocooler units and associated radiative cooling panels. Free piston stirling cycle cryocoolers are often envisioned for this task. Although on first glance this type of cryocooler seems well suited to the task (small size, self-contained, relatively simple and reliable) further consideration of the system as a whole indicates some shortcomings. The small size of free piston Stirling cycle cryocoolers means the cold and hot regions are very close together. This means that some additional system must be provided to carry waste heat away to a remote heat rejection element (radiative cooler). This is typically a pumped loop fluid system, adding more components with their mass and possible failure points. It also means that when the cryocoolers are not operational for any reason, they introduce an additional heat leak path. So a system with failed cryocoolers or insufficient power to run them continuously may actually lose cryogenic fluid to boil off faster than a system without active cooling.

Reverse Brayton Cycle devices have also been proposed for active cooling of cryogenic liquid storage tanks. Although these systems benefit in having fluid interfaces which can more easily be used to interface the cold end of the coolant circuit with the storage tank or the warm end with the heat rejector without needing an additional heat transfer circuit (Broad Area Cooling), they still use a separate refrigerant fluid and lines and therefore increase system mass, failure risk, and complexity.

There are two main problems with in space transfer of cryogenic fluids. The first is chill down of initially warm and dry tank walls. The second is bulk transfer of liquid from one tank to another. These two problems echo the phases of cryogenic fluid transfer in terrestrial applications. In terrestrial applications tank chill down is typically accomplished by flowing liquid and venting boiloff vapor. Techniques have been proposed to lessen boiloff losses in space, such as the charge-hold-vent algorithm. These methods accept boiloff losses from tank chilldown, they just try to minimize those losses. A best case scenario for these techniques would be a fluid mass loss equivalent to the initial stored thermal energy in the tank walls divided by the fluid specific heat of vaporization.

### BRIEF SUMMARY OF THE INVENTION

An autogenous closed loop cooling system would use the cryogenic fluid itself as the refrigerant. A compressor would push propellant boiloff vapor through a cooling element (radiator) and thermal expansion valve back into the storage tank. An expander upstream of the thermal expansion valve would increase the cooling capacity and system efficiency. A crossflow heat exchanger would transfer heat energy from the flow exiting the expander to the flow entering the compressor.

In a Propellant Depot operation with a closed loop phase change system, tank chilldown could conceptually be achieved with no loss of fluid. When cryogenic liquid is admitted from the full tank (depot) to the warm empty tank it will vaporize, removing thermal energy from the warm tank walls. The cooling system compressor inlet now draws from the warm tank ullage and exhausts into tubing running to the cooling element (radiator panel).

The system is sized to produce some amount of condensation at the outlet of a thermal expansion valve (Joule Thomson device) before the fluid returns to the storage tank.

### BRIEF DESCRIPTION OF THE DRAWINGS

FIG. 1 is a schematic diagram of the Autogenous Cooling System.

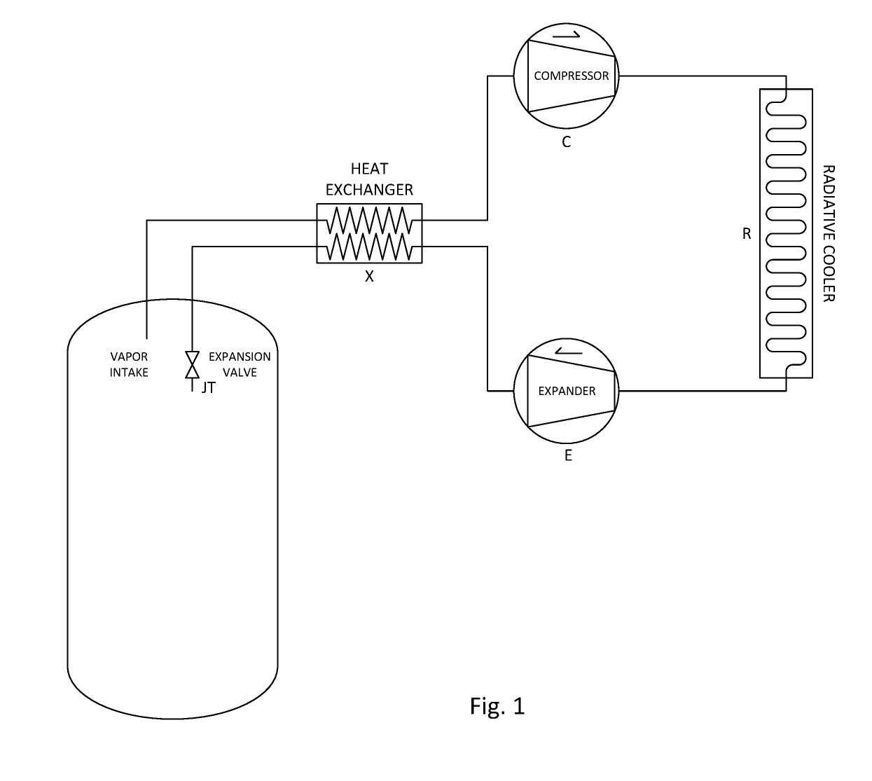

FIG. 2 is a variation using a rocket nozzle as the heat rejecting radiator.

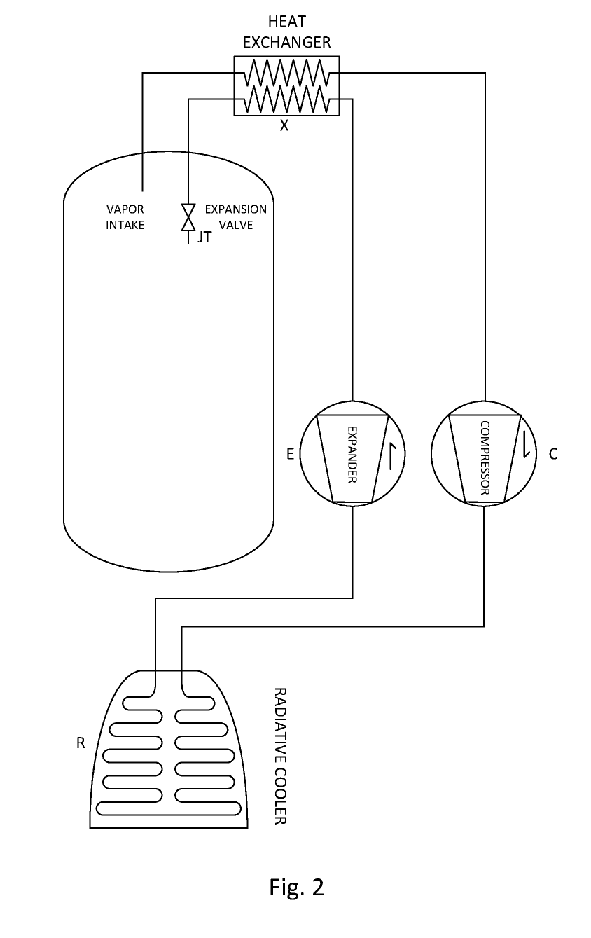

FIG. 3 shows the Propellant Depot mode of operation for propellant transfer.

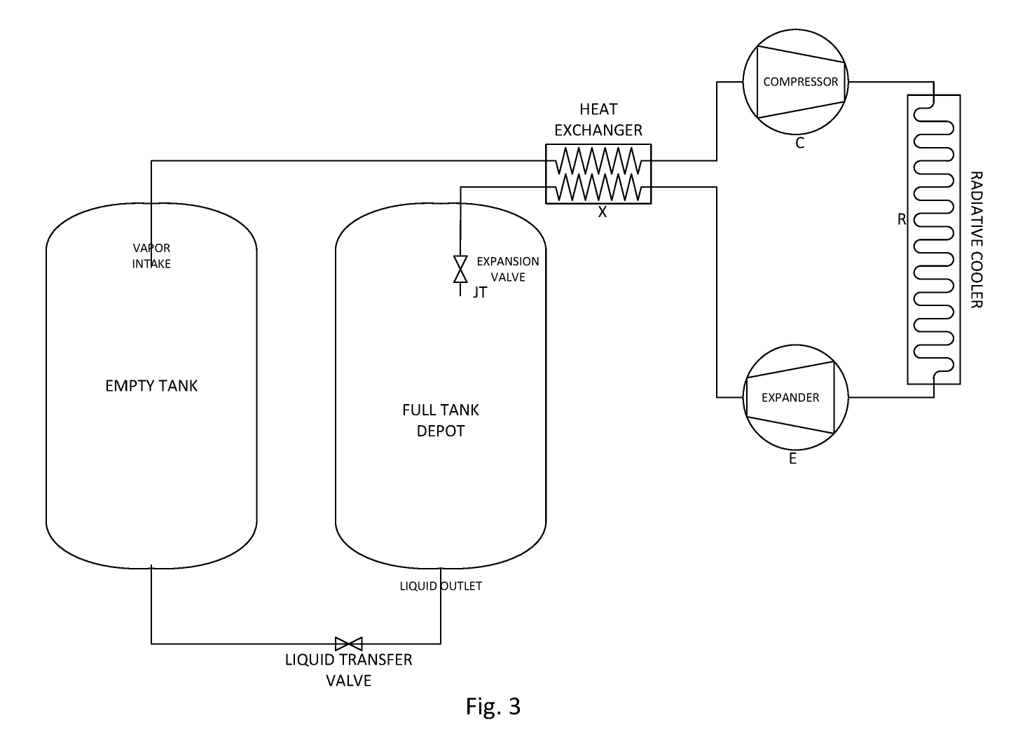

### DETAILED DESCRIPTION OF THE INVENTION

A compressor (C) draws propellant vapor from the tank through a heat exchanger (X) which increases the vapor temperature. The compressor increases the flow pressure and the outlet stream flows through a radiative cooling element (R) where it rejects heat energy to space. The fluid returning from the cooling element flows through an expander element (E) where some of the pressure energy in the flow is recovered. The work output from this compressor may be used to partially power the compressor, increasing overall system efficiency. From there the fluid passes through the other side of the heat exchanger, which further lowers its temperature, before entering the final pressure reducing valve (JT). This final flow restriction, or Joule-Thomson device, induces some amount of condensation in the fluid stream re-entering the storage vessel.

Many liquid propellant rocket engines utilize a regenerative cooling system. This cooling method directs cryogenic propellant through parts of the rocket nozzle and/or combustion chamber wall before injecting it into the combustion chamber. This prevents overheating of parts of the engine and increases overall engine efficiency. There is an opportunity to use these same passages in the rocket nozzle as all or part of the heat rejecting radiative cooling element in an Autogenous Cooling system. This may increase complexity of the system, but may also decrease overall vehicle mass for long duration missions.

### FIGURES

1. Autogenous Cooling System Schematic

2. Variation using rocket nozzle as radiative cooling element

3. Propellant Depot mode of operation

### PARTS

X. Heat Exchanger

C. Compressor

R. Radiative Cooler

E. Expander

JT. Joule-Thomson Expansion Valve

We claim:

1. A process for retaining rocket propellant in cryogenic liquid form in a tank in outer space by using the propellant itself as the working fluid or refrigerant, comprised of:
A vapor intake,
A compressor,
A heat exchanger,
A heat rejecting element (radiative cooling to space environment)
An expander which extracts energy from the working fluid to partially power the compressor element,
A throttling valve which expands the working fluid resulting in some phase change from vapor to liquid

2. An autogenous cooling system as in claim 1, wherein same system is capable of cooling an empty warm tank in preparation for receiving cryogenic liquid.

3. The process of claim 1 wherein the prime mover (compressor) for the thermodynamic cooling cycle also effects liquid transfer out of the storage tank.
